(19) United States
(12) Patent Application Publication
(10) Pub. No.: US 2026/0200337 A1
(43) Pub. Date: Jul. 16, 2026

(54) CONTROL SYSTEM FOR VEHICLE

(71) Applicant: TOYOTA JIDOSHA KABUSHIKI KAISHA, Toyota-shi (JP)

(72) Inventors: Kazuma AOKI, Toyota-shi (JP); Takeshi Ishiwada, Anjo-shi (JP); Hiroto Amada, Nagakute-shi (JP); Noritaka Takuda, Okazaki-shi (JP); Tatsuya Kawamura, Nagoya-shi (JP); Takeshi Kitahata, Toyota-shi (JP)

(73) Assignee: TOYOTA JIDOSHA KABUSHIKI KAISHA, Toyota-shi (JP)

(21) Appl. No.: 19/438,928

(22) Filed: Jan. 2, 2026

(30) Foreign Application Priority Data
Jan. 10, 2025 (JP) 2025-004373

(51) Int. Cl. B60L 15/20; B60K 1/00; B60K 17/04; F16H 63/34

(52) U.S. Cl. CPC B60L 15/20; B60K 1/00; B60K 17/04; F16H 63/3416; B60L 2240/423; B60L 2240/642

(57) ABSTRACT

A control system for a vehicle configured to suppress vibrations and shocks when releasing a parking lock mechanism in a situation where a drive shaft is twisted. The vehicle comprises: a drive shaft in which one end thereof is joined to a wheel; a motor that applies a torque to the drive shaft; and a parking lock mechanism that selectively stops a rotation of a rotary member arranged between the motor and the drive shaft. The control system is configured to control the motor to generate a torque determined based on the inclination direction of the vehicle in the pitching direction when releasing the rotary member locked by the parking lock mechanism.

### CROSS-REFERENCE TO RELATED APPLICATIONS

The present disclosure claims the benefit of Japanese Patent Application No. 2025-004373 filed on January 10, 2025 with the Japanese Patent Office, the entire contents of which are hereby incorporated by reference.

### BACKGROUND

### Technical Field

The embodiment of the present disclosure relates to the art of a control system for a vehicle in which a drive shaft is selectively locked by a parking lock mechanism.

### Discussion of the Related Art

JP-A-2020-100312 discloses a control device applied to a vehicle comprising: a parking lock mechanism including a parking gear interlocked with a wheel, and a parking pawl engaged with the parking gear to lock the parking gear; a foot brake device that is actuated when a brake pedal is depressed by a driver to apply a braking force to the wheel; and an electric parking brake that is actuated in conjunction with the parking lock mechanism to continuously apply a braking force to the wheel. The control device described in JP-A-2020-100312 is configured to apply the braking force continuously to the wheel by the foot brake device even if the brake pedal is released by the driver after a shift lever is moved to a parking position and before the braking force is applied to the wheels by the electric parking brake, if an inclination angle of a road surface is equal to or greater than a predetermined angle.

The control device described in JP-A-2020-100312 is configured such that the drive shaft is not twisted by applying the braking torque to the wheels by the foot brake device until the braking torque of the electric parking brake acts on the wheel. That is, the braking torque is always applied to the wheel as long as the wheel is halted by the parking lock mechanism. However, the drive shaft may be twisted in a case that the electric parking brake cannot be activated, in a case that the vehicle is not provided with the electric parking brake, or in a case that the control device does not have a function to apply the braking torque to the wheel by the foot brake device until the braking torque generated by the electric parking brake acts on the wheel. The control device described in JP-A-2020-100312 is conceived without taking into consideration a torsion of the drive shaft. Therefore, the control device described in JP-A-2020-100312 may not suppress vibrations and shocks when releasing the parking lock mechanism in a situation where the drive shaft is twisted.

### SUMMARY

The embodiment of the present disclosure has been conceived noting the foregoing technical problems, and it is therefore an object of the present disclosure to provide a control system for a vehicle configured to suppress vibrations and shocks when releasing a parking lock mechanism in a situation where a drive shaft is twisted.

A control system according to the exemplary embodiment of the present disclosure is applied to a vehicle, comprising: a drive shaft in which one end thereof is joined to a wheel; a motor that applies a torque to the drive shaft; a parking lock mechanism that stops a rotation of a predetermined rotary member arranged between the motor and the drive shaft by locking the rotary member, and that allows the rotary member to rotate by releasing the rotary member; a case that holds the motor, the parking lock mechanism, and a torque transmission member delivering the torque from the motor to the drive shaft; and a plurality of mounts connecting the case to a vehicle body. In order to achieve the above-explained objective, according to the exemplary embodiment of the present disclosure, the control system is provided with a controller that controls the motor, comprising: a parking determiner configured to determine that the rotary member is locked by the parking lock mechanism; an inclination determiner that is configured to determine an inclination direction of the vehicle in the pitching direction; and a motor controller that is configured to control the motor to generate a torque determined in accordance with the inclination direction of the vehicle in the pitching direction when the rotary member locked by the parking lock mechanism is released by the parking lock mechanism.

In a non-limiting embodiment, the motor controller may be further configured to: increase the torque generated by the motor with an increase in an inclination angle of the vehicle in the pitching direction; and change a magnitude of the torque generated by the motor with respect to the inclination angle depending on the inclination direction of the vehicle in the pitching direction.

In a non-limiting embodiment, rigidities for supporting the case may be different in the pitching direction of the vehicle.

In a non-limiting embodiment, the plurality of the mounts may include: a first mount connecting a rear end surface of the case in the longitudinal direction of the vehicle to the vehicle body; a second mount connecting one of side surfaces in the width direction of the vehicle to the vehicle body; and a third mount connecting the other one of side surfaces in the width direction of the vehicle to the vehicle body.

Thus, in the vehicle to which the control system according to the exemplary embodiment of the present disclosure is applied, the motor, the parking lock mechanism, and the torque transmission member delivering the torque from the motor to the drive shaft are held in the case connected to the vehicle body through a plurality of the mounts. According to the exemplary embodiment of the present disclosure, the controller is configured to control the motor to generate a torque determined in accordance with the inclination direction of the vehicle in the pitching direction when the parking lock mechanism releases the rotary member being locked. Therefore, although the rigidities for supporting the case by the vehicle body through the mounts in the longitudinal direction of the vehicle are not identical to each other, the torque generated by the motor may be optimized in accordance with the orientation of the vehicle in the pitching direction. For this reason, vibrations and shocks may be reduced when releasing the intermediate shaft by the parking lock mechanism 11 regardless of the inclination direction of the vehicle. In other words, positions and the number of the mounts supporting the case may be altered without restriction and hence design flexibility of the mounts may be enhanced.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the control system according to the exemplary embodiment of the present disclosure is applied;

FIG. 2 is a perspective view schematically showing a structure for fixing the case to the vehicle body;

FIG. 3 is a block diagram showing functions of the controller;

FIG. 4 is a flow chart showing one example of a routine for determining an assist torque to be generated by the motor; and

FIG. 5 shows one example of a map for determining a target torque in accordance with an inclined direction and an inclination angle of the vehicle.

### DETAILED DESCRIPTION OF THE EMBODIMENT(S)

An embodiment of the present disclosure will now be explained with reference to the accompanying drawings. Note that the embodiments shown below are merely examples of the present disclosure, and do not limit the present disclosure.

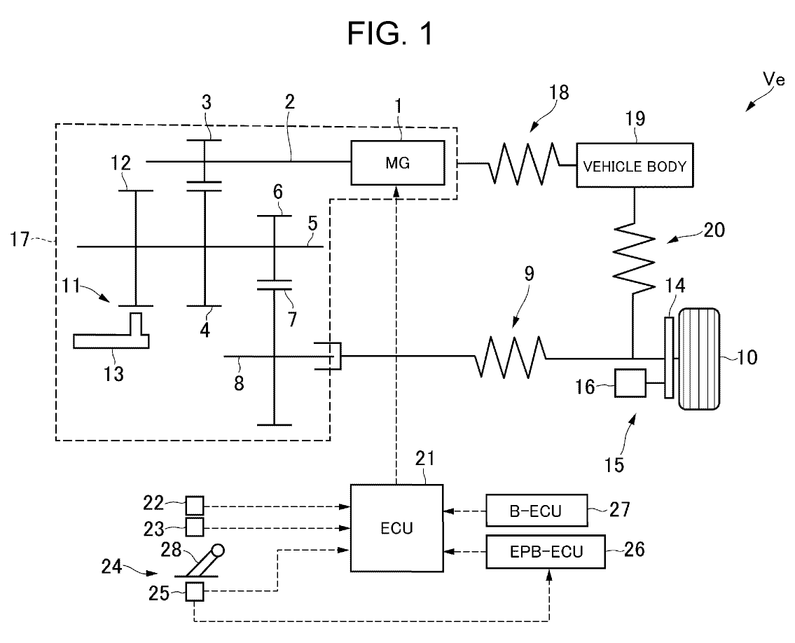

Referring now to FIG. 1, there is shown one example of a structure of a vehicle Ve to which the control system according to the exemplary embodiment of the present disclosure is applied. The vehicle Ve shown in FIG. 1 is an electric vehicle comprising a motor (referred to as MG in FIG. 1) 1 as a prime mover. As the motor 1, a motor serving as a prime mover of conventional electric vehicles and hybrid vehicles may be employed. The motor 1 is operated as a motor to generate a driving torque by supplying electric power thereto from a power storage device (not shown), and as a generator to translate a kinetic power of an output shaft 2 thereof into electric power at least partially by rotating the output shaft 2 passively. For example, a permanent magnet synchronous motor or an induction motor may be adopted as the motor 1.

A first drive gear 3 is mounted on the output shaft 2 of the motor 1, and a first driven gear 4 is mounted on an intermediate portion of the intermediate shaft 5 extending parallel to the output shaft 2 of the motor 1 to be meshed with the first drive gear 3. The first driven gear 4 is diametrically larger than the first drive gear 3 so that the first drive gear 3 and the first driven gear 4 serve as a reduction gear pair.

A second drive gear 6 is mounted on one end of the intermediate shaft 5, and a second driven gear 7 is mounted on an output shaft 8 extending parallel to the output shaft 2 and the intermediate shaft 5 to be meshed with the second drive gear 6. The second driven gear 7 is diametrically larger than the second drive gear 6 so that the second drive gear 6 and the second driven gear 7 also serve as a reduction gear pair. One end of the drive shaft 9 is joined to the output shaft 8 to rotate integrally therewith, and a wheel 10 is joined to the other end of the drive shaft 9.

The vehicle Ve is provided with a parking lock mechanism 11 that stops the rotation of the intermediate shaft 5 by locking the intermediate shaft 5, and allows the intermediate shaft 5 to rotate by releasing the intermediate shaft 5. A structure of the parking lock mechanism 11 is similar to those of parking lock mechanisms employed in the conventional vehicles. Specifically, the parking lock mechanism 11 comprises a parking lock gear 12 mounted on the other end of the intermediate shaft 5, a parking pawl 13 selectively engaged with the parking lock gear 12, and an actuator (not shown) for rotating the parking pawl 13. When a shift lever 28 of an after-mentioned shifting device 24 is moved to a parking position, the parking pawl 13 is rotated by the actuator to be engaged with the parking lock gear 12 thereby stopping a rotation of the parking lock gear 12. As a result, the rotation of the drive shaft 9 connected to the parking lock gear 12 through the intermediate shaft 5 in a torque transmittable manner is stopped.

A braking torque is applied to the wheel 10 by a brake device 14 according to a depression of a brake pedal (not shown) operated by a driver. As the brake device 14, brake devices arranged in the conventional vehicles may be employed. For example, a disk brake that applies a braking torque to the wheel 10 by clamping a brake rotor rotating integrally with the wheel 10 by a brake pad, and a drum brake that applies a braking torque to the wheel 10 by pressing a brake shoe from inside of a drum rotating integrally with the wheel 10 may be adopted as the brake device 14. A clamping force of the brake pad and a pushing force of the brake shoe may be controlled by an actuator (not shown) that generates a hydraulic pressure or an electromagnetic force in accordance with a depression of the brake pedal.

The vehicle Ve further comprises an electric parking brake (hereinafter, referred to as EPB) 15. When the shift lever 28 of the shifting device 24 is moved to the parking position, a motor 16 is activated to actuate a caliper or a brake shoe (neither of which are shown) of the EPB15 to apply a braking torque to the wheel 10. Whereas, when the shift lever 28 of the shifting device 24 is moved to a position other than the parking position, the EPB15 reduces the braking torque applied to the wheel 10. In order to fit the motor 16 easily into the vehicle Ve, the motor 16 may be arranged in a vehicle body, and the motor 16 and the caliper or the brake shoe may be connected to each other through a wire. In this case, the caliper and the brake shoe are actuated by rotating the motor 16 to wind up the wire.

In the vehicle Ve, the motor 1, a gear train for delivering a torque from the motor 1 to the output shaft 8, and a torque transmission member for delivering a torque from the motor 1 to the drive shaft 9 such as the output shaft 8 are held in a case 17, and the case 17 is connected to a vehicle body 19 through a mount 18. The wheel 10 is connected to the vehicle body 19 through a suspension 20.

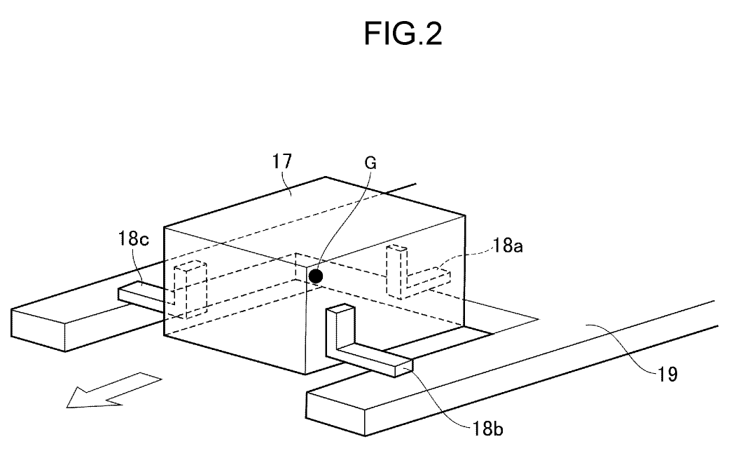

Turning to FIG. 2, there is schematically shown one example of a structure fixing the case 17 to the vehicle body 19. In FIG. 2, the arrow indicates a front section of the vehicle Ve in the longitudinal direction. As illustrated in FIG. 2, the case 17 is supported by the vehicle body 19 through a first mount 18a, a second mount 18b, and a third mount 18c. In the case 17, specifically, a rear end surface is connected to the vehicle body 19 through the first mount 18a at a central portion in the width direction of the vehicle Ve, one of side surfaces in the width direction of the vehicle Ve is connected to the vehicle body 19 through the second mount 18b at a portion in front of the center of gravity G of a transaxle assembly, and the other one of side surfaces in the width direction of the vehicle Ve is connected to the vehicle body 19 through the third mount 18c at a portion in front of the center of gravity G of the transaxle assembly. Thus, the case 17 is not supported at symmetrical points in the longitudinal direction of the vehicle Ve. That is, stiffnesses at the points to support the case 17 in the pitching direction of the vehicle Ve are different. In addition, each of the first mount 18a, the second mount 18b, and the third mount 18c is situated at a substantially same level as the center of gravity G of the transaxle assembly in the height direction of the vehicle Ve.

An operating mode of the vehicle Ve is allowed to be shifted to a parking mode by moving the shift lever 28 to the parking position while depressing the brake pedal. In the parking mode, a rotation of the intermediate shaft 5 is stopped by the parking lock mechanism 11, and a braking torque is applied to the wheel 10 by the EPB15.

When the above-mentioned shifting operation is executed by the driver to shift the operating mode to the parking mode, the rotation of the intermediate shaft 5 is stopped by the parking lock mechanism 11 before the braking torque is applied to the wheel 10 by the EPB15. In this situation, given that the vehicle Ve is parked on a slope or that the vehicle Ve is parked such that some of the wheels 10 is/are stopped on a curb, the vehicle Ve is inclined in the pitching direction. In this case, if the driver returns the brake pedal before the braking torque is applied to the wheel 10 by the EPB15, the wheel 10 will rotate even though the rotation of an input section of the drive shaft 9 is stopped. In addition, if the EPB15 cannot function properly for some reason, the wheel 10 will also rotate after returning the brake pedal even though the rotation of the input section of the drive shaft 9 is stopped. As a result, the drive shaft 9 is twisted. That is, the drive shaft 9 is subjected to a torque (i.e., a torsional torque) according to an elastic modulus and a torsion angle thereof.

In the above-described situations, the torsion angle (that is, the torsional torque) of the drive shaft 9 varies in accordance with an inclination angle of the vehicle Ve. Specifically, a load acting on the vehicle Ve in the longitudinal direction according to the inclination angle of the vehicle Ve is applied to a contact surface of the wheel 10 with a road surface, and such load and a torque according to a radius of the wheel 10 act on one end of the drive shaft 9. Whereas, the other end of the drive shaft 9 is locked by the parking lock mechanism 11 to prevent a rotation thereof. Therefore, the drive shaft 9 is gradually twisted and subjected to a torsional torque according to a torsion angle and the elastic modulus thereof. Eventually, when the torque applied to the drive shaft 9 from the wheel 10 and the torsional torque acting on the drive shaft 9 according to the torsion angle are balanced with each other, an increase in the torsion angle of the drive shaft 9 stops. Specifically, the drive shaft 9 is twisted in a direction corresponding to a direction of inclination of the vehicle Ve.

When the drive shaft 9 is twisted, a load is transmitted to the case 17 by establishing a reaction force by the parking lock mechanism 11, and consequently, the mounts 18a, 18b, and 18c are distorted by the case 17. As described above, the case 17 is not supported by the mounts 18a, 18b, and 18c at symmetrical positions in the longitudinal direction of the vehicle Ve. That is, the rigidities at the points to support the case 17 are different in the pitching direction of the vehicle Ve. Therefore, distortions of the mount 18a, 18b, and 18c in the situation where the vehicle Ve is inclined such that the front section thereof is oriented upward are individually different from distortions of the mount 18a, 18b, and 18c in the situation where the vehicle Ve is inclined such that the front section thereof is oriented downward.

If the shifting operation for selecting a mode other than the parking mode is executed in the situation where the mounts 18a, 18b, and 18c are distorted due to the torsion of the drive shaft 9, the torsion of the drive shaft 9 is eliminated at a timing when the intermediate shaft 5 is unlocked by the parking lock mechanism 11. Consequently, the distortions of the mounts 18a, 18b, and 18c are reduced. In this situation, the torque acting on drive shaft 9 is pulsated according to the elastic moduli of the drive shaft 9 and the mounts 18a, 18b, and 18c. As a result, the case 17 is vibrated, and the resultant vibrations propagate to the vehicle body 19 through the mounts 18a, 18b, and 18c while attenuating thereby vibrating the vehicle Ve.

In the situation where the drive shaft 9 is twisted, such vibrations of the vehicle Ve may be suppressed by generating an assist torque by the motor 1 to counteract the torsional torque acting on the drive shaft 9 and to reduce the distortions of the mounts 18a, 18b, and 18c, when the intermediate shaft 5 is released by the parking lock mechanism 11.

However, the case 17 is not supported by the mounts 18a, 18b, and 18c at symmetrical positions in the longitudinal direction of the vehicle Ve, and hence the stiffnesses at the positions to support the case 17 in the pitching direction of the vehicle Ve are different. Therefore, the distortions of the mount 18a, 18b, and 18c in the situation where the vehicle Ve is inclined such that the front section thereof is oriented upward, and the distortions of the mount 18a, 18b, and 18c in the situation where the vehicle Ve is inclined such that the front section thereof is oriented downward, are individually different. For this reason, different assist torque of the motor 1 is required to reduce the distortions of the mounts 18a, 18b, and 18c depending on an orientation of inclination of the vehicle Ve in the pitching direction.

Therefore, the control system according to the exemplary embodiment of the present disclosure is configured to change the assist torque of the motor 1 in accordance with the orientation of the vehicle Ve in the pitching direction. Specifically, the control system is configured to change a magnitude of the assist torque generated by the motor 1 depending on the case in which the vehicle Ve is inclined such that the front section of the vehicle Ve is oriented upward in the vertical direction, and the case in which the vehicle Ve is inclined such that the front section of the vehicle Ve is oriented downward in the vertical direction.

In order to control the motor 1 in that way, the vehicle Ve is provided with an electronic control unit (hereinafter referred to as the ECU) 21 as a controller for controlling the motor 1. The ECU21 comprises a microcomputer configured to control an output torque of the motor 1 on the basis of incident signals using calculation expressions stored in advance.

The ECU 21 is connected with an acceleration sensor 22 that detects a longitudinal acceleration of the vehicle Ve, a resolver 23 that detects a rotational speed (or a rotational angle) of the motor 1, and a shift sensor 25 that detects the operating mode selected by the shifting device 24, so that signals are transmitted to the ECU 21 from the sensors 22, 23, and 25. In addition, an EPB-ECU 26 for controlling the EPB 15 and a B-ECU 27 for controlling the brake device 14 are also connected with the ECU 21 so that signals are also transmitted to the ECU 21 from the EPB-ECU 26 and the B-ECU 27.

For example, a so-called momentary shifting device may be adopted as the shifting device 24. In this case, when the shift lever 28 is moved from the initial position to a desired position, a signal corresponding to the position of the shift lever 28 is transmitted to the ECU 21 from the shift sensor 25, and when the shift lever 28 is released, the shift lever 28 returns to the initial position. As an option, the shifting device 24 may be provided with a parking button for selecting a parking mode, and the shift sensor 25 may be activated by pressing the parking button.

The EPB-ECU 26 is connected with the shift sensor 25. Specifically, the EPB-ECU 26 is configured to determine whether the EPB 15 is activated based on a signal transmitted from the shift sensor 25, and to transmit a command signal to the ECU 21 or the motor 16 based on a determination result. For example, a signal representing a depression of the brake pedal, a signal representing a pedal force applied to the brake pedal, and a signal representing a pressure of a master cylinder are transmitted to the B-ECU27. Otherwise, a detection signal of a hydraulic pressure or an electromagnetic force for generating a braking torque by the brake device 14 is transmitted to the B-ECU27. Specifically, the B-ECU27 is configured to calculate a braking torque to be generated by the brake device 14 based on the incident signals, and to transmit a command signal to the ECU 21 based on the calculated braking torque.

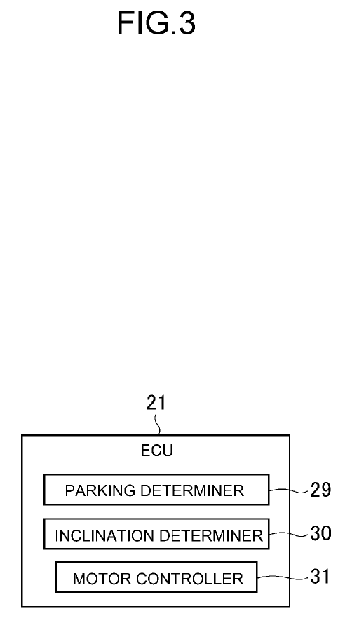

Turning to FIG. 3, there are shown functions of the ECU 21. As shown in FIG. 3, the ECU 21 comprises a parking determiner 29, an inclination determiner 30, and a motor controller 31.

The parking determiner 29 is configured to determine whether the vehicle Ve is in the parking mode in which the rotation of the intermediate shaft 5 is stopped by the parking lock mechanism 11. In other words, the parking determiner 29 is configured to determine whether the intermediate shaft 5 is locked by the parking lock mechanism 11. Specifically, the parking determiner 29 determines that the vehicle Ve is in the parking mode based on a fact that a predetermined time has elapsed since the shift lever 28 was moved to the parking position, or a fact that a command signal for actuating the parking pawl 13 is transmitted to the actuator.

The inclination determiner 30 is configured to determine an inclination direction of the vehicle Ve in the pitching direction. Specifically, the inclination determiner 30 determines the inclination direction of the vehicle Ve in the pitching direction based on a detection value of the acceleration sensor 22. In the following explanation, an inclination direction in the pitching direction in which the front section of the vehicle Ve is oriented upward in the vertical direction compared to that in a situation where the vehicle Ve is in a horizontal posture will be referred to as a positive direction, and an inclination direction in the pitching direction in which the front section of the vehicle Ve is oriented downward in the vertical direction compared to that in the situation where the vehicle Ve is in a horizontal posture will be referred to as a negative direction. In addition, the inclination determiner 30 also determines an inclination angle of the vehicle Ve in the pitching direction.

The motor controller 31 is configured to control the motor 1 to generate a torque determined in accordance with an inclination direction and an inclination angle of the vehicle Ve in the pitching direction.

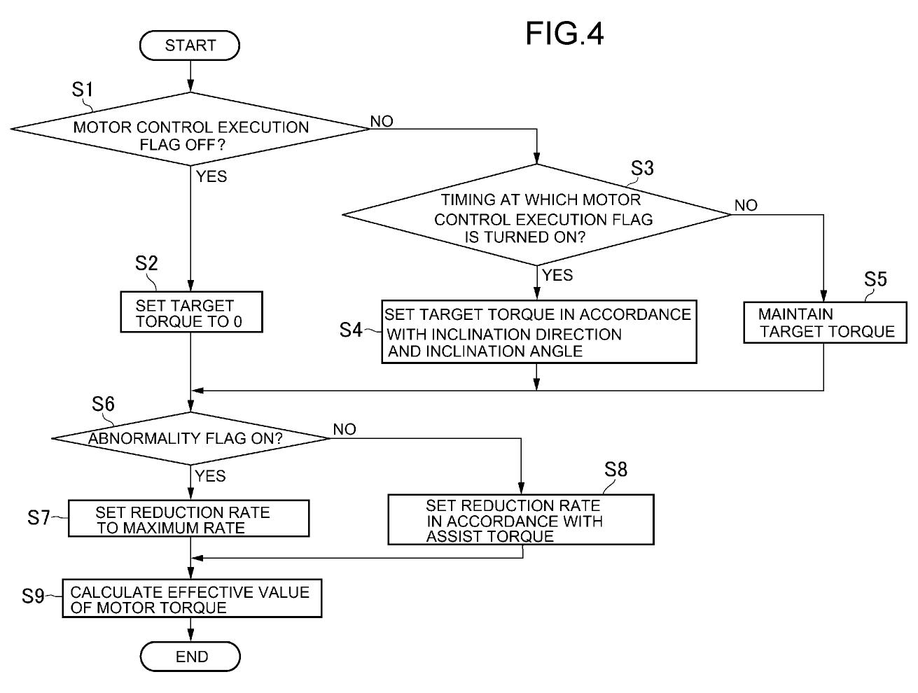

Turning to FIG. 4, there is shown one example of a routine executed by the ECU 21 to determine the assist torque to be generated by the motor 1. At step S1, it is determined whether or not a motor control execution flag is off. Specifically, the motor control execution flag is turned on in a situation where the drive shaft 9 is twisted to a degree at which the vehicle Ve is vibrated when the parking lock mechanism 11 is released. For example, the motor control execution flag is turned on in the situation where the intermediate shaft 5 is locked by the parking lock mechanism 11, in the situation where the braking torque applied to the wheel 10 after locking the intermediate shaft 5 by the parking lock mechanism 11 is equal to or less than a predetermined magnitude so that the wheel 10 is allowed to rotate, and in the situation where an absolute value of the inclination angle of the vehicle Ve in the pitching direction is equal to or greater than a predetermined degree.

If the motor control execution flag is off so that the answer of step S1 is YES, the routine progresses to step S2 to set a target value of the assist torque to be generated by the motor 1 (hereinafter, simply referred to as the target torque) to zero. By contrast, if the motor control execution flag is on so that the answer of step S1 is NO, the routine progresses to step S3 to determine whether it is a timing at which the motor control execution flag being off is turned on. Such determination at step S3 may be made based on whether or not the answer of step S1 in the previous routine was YES.

If it is the timing at which the motor control execution flag being off is turned on so that the answer of step S3 is YES, the routine progresses to step S4 to set the target torque in accordance with an orientation of the vehicle Ve in the pitching direction (hereinafter, simply referred to as the inclination direction). To this end, a map for determining a magnitude of the assist torque corresponding to the inclination direction and the inclination angle of the vehicle Ve is prepared based on a result of an experiment conducted in advance, and the map is stored in the ECU 21. At step S4, therefore, the target torque is determined with reference to the map based on the inclination direction and the inclination angle of the vehicle Ve determined in accordance with the acceleration detected by the acceleration sensor 22. In order to set the target torque at step S4, it is possible to employ not only the inclination angle of the vehicle Ve detected at the timing when the parking lock mechanism 11 locking the intermediate shaft 5 releases the intermediate shaft 5, but also the inclination angle of the vehicle Ve detected at the timing when the parking lock mechanism 11 locks the intermediate shaft 5 to park the vehicle Ve.

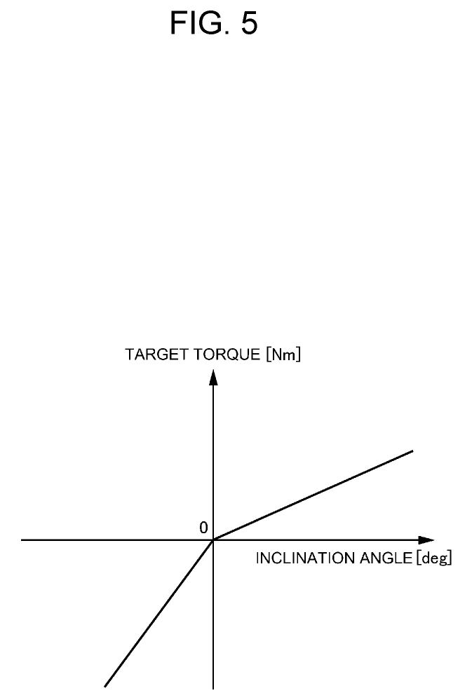

An example of the map is shown in FIG. 5. In FIG. 5, the horizontal axis represents the inclination angle of the vehicle Ve, and the vertical axis represents the target torque. In the example shown in FIG. 5, the target torque with respect to the inclination angle in the case that the inclination direction of the vehicle Ve is positive is set to be smaller than the target torque with respect to the inclination angle in the case that the inclination direction of the vehicle Ve is negative. In other words, the target torque with respect to the inclination angle of the case in which the vehicle Ve is inclined such that the front section of the vehicle Ve is oriented upward in the vertical direction is set to be smaller than the target torque with respect to the inclination angle of the case in which the vehicle Ve is inclined such that the front section of the vehicle Ve is oriented downward in the vertical direction. That is, since the case 17 is not fixed to the vehicle body 19 at symmetrical points in the longitudinal direction of the vehicle Ve by the mounts 18a,18b, and 18c, an increase in the target torque with respect to an increase in the inclination angle in the case that the inclination direction of the vehicle Ve is positive is smaller than that in the case that the inclination direction of the vehicle Ve is negative.

By contrast, if it is not the timing at which the motor control execution flag being off is turned on, that is, if the motor control execution flag has already been turned on and hence the target value of the assist torque to be generated by the motor 1 has already been set so that the answer of step S3 is NO, the routine progresses to step S5 to maintain the target value of the assist torque of the motor 1 to the previous value. That is, once the target value of the assist torque to be generated by the motor 1 was set at the timing when the motor control execution flag was turned on, the target value of the assist torque of the motor 1 is maintained to that value.

Then, a reduction rate of the assist torque generated by the motor 1 is determined. To this end, it is determined at step S6 whether or not some kind of failure e.g., a communication error that the ECU 21 cannot receive a signal representing the braking torque established by the brake device 14 or EPB15 has occurred while the motor 1 is generating the assist torque. At step S6, specifically, it is determined whether or not an anomality flag is on. For example, the anomality flag is turned on based on a signal transmitted between the EPB-ECU 26 or the B-ECU 27 and the ECU 21.

If the anomality flag is on so that the answer of step S6 is YES, the routine progresses to step S7 to set the reduction rate of the assist torque of the motor 1 to the maximal rate determined based on the specification of the motor 1 in advance. By contrast, if the anomality flag is off so that the answer of step S6 is NO, the routine progresses to step S8 to set the reduction rate of the assist torque of the motor 1 to a rate determined in accordance with a magnitude of the assist torque of the motor 1 (i.e., the target torque) such that the assist torque is reduced within a predetermined period of time.

Then, at step S9, an effective value of the output torque of the motor 1 is calculated by multiplying the target value of the assist torque of the motor 1 by the reduction rate set at step S7 or S8 and an elapsed time, and thereafter the routine returns.

Thus, according to the exemplary embodiment of the present disclosure, the motor 1 generates a torque according to the orientation of the vehicle Ve in the pitching direction. Specifically, the control system changes the magnitude of the torque of the motor 1 with respect to the inclination angle of the vehicle Ve depending on the case in which the vehicle Ve is inclined in the pitching direction such that the front section thereof is oriented upward and the case in which the vehicle Ve is inclined in the pitching direction such that the front section thereof is oriented downward. Therefore, although the rigidities for supporting the case 17 by the vehicle body 19 through the mounts 18a, 18b, and 18c in the longitudinal direction of the vehicle Ve are not identical to each other, the torque generated by the motor 1 may be optimized in accordance with the orientation of the vehicle Ve in the pitching direction. For this reason, vibrations and shocks may be reduced when releasing the intermediate shaft 5 by the parking lock mechanism 11 regardless of the inclination direction of the vehicle Ve. In other words, positions and the number of the mounts 18a, 18b, and 18c supporting the case 17 may be altered without restriction and hence design flexibility of the mounts 18a, 18b, and 18c may be enhanced.

Although the above examples of the present disclosure have been described, it will be understood by those skilled in the art that the present disclosure should not be limited to the described examples, and various changes and modifications can be made within the scope of the present disclosure. For example, the control system according to the exemplary embodiment of the present disclosure may also be applied to an electric vehicle in which torque is distributed from one motor to a pair of front wheels or rear wheels or to all wheels. In addition, the control system according to the exemplary embodiment of the present disclosure may also be applied to a hybrid-vehicle in which a prime mover includes a motor and an engine. Further, a configuration to join the drive shaft 9 to the motor 1, and the rotary member whose rotation is stopped by the parking lock mechanism 11 are not limited to those shown in FIG. 1. Furthermore, the EPB 15 may be omitted from the vehicle Ve.

What is claimed is:

1. A control system for a vehicle, comprising:
a drive shaft in which one end thereof is joined to a wheel;
a motor that applies a torque to the drive shaft;
a parking lock mechanism that stops a rotation of a predetermined rotary member arranged between the motor and the drive shaft by locking the rotary member, and that allows the rotary member to rotate by releasing the rotary member;
a case that holds the motor, the parking lock mechanism, and a torque transmission member delivering the torque from the motor to the drive shaft; and
a plurality of mounts connecting the case to a vehicle body,
the control system comprising:
a controller that controls the motor,
wherein the controller comprises:
a parking determiner configured to determine that the rotary member is locked by the parking lock mechanism;
an inclination determiner that is configured to determine an inclination direction of the vehicle in the pitching direction; and
a motor controller that is configured to control the motor to generate a torque determined in accordance with the inclination direction of the vehicle in the pitching direction when the rotary member locked by the parking lock mechanism is released by the parking lock mechanism.

2. The control system for the vehicle as claimed in claim 1, wherein the motor controller is further configured to:
increase the torque generated by the motor with an increase in an inclination angle of the vehicle in the pitching direction; and
change a magnitude of the torque generated by the motor with respect to the inclination angle depending on the inclination direction of the vehicle in the pitching direction.

3. The control system for the vehicle as claimed in claim 1, wherein rigidities for supporting the case are different in the pitching direction of the vehicle.

4. The control system for the vehicle as claimed in claim 3, wherein the plurality of the mounts include:
a first mount connecting a rear end surface of the case in the longitudinal direction of the vehicle to the vehicle body;
a second mount connecting one of side surfaces in the width direction of the vehicle to the vehicle body; and
a third mount connecting the other one of side surfaces in the width direction of the vehicle to the vehicle body.
